(19) United States
(12) Patent Application Publication
(10) Pub. No.: US 2018/0100772 A1
(43) Pub. Date: Apr. 12, 2018

(54) TEMPERATURE MEASUREMENT DEVICE

(71) Applicant: Kabushiki Kaisha Toshiba, Minato-ku (JP)

(72) Inventors: Hirotaka UEMURA, Kawasaki (JP); Kazuya Ohira, Nerima (JP); Nobuo Suzuki, Kamakura (JP)

(73) Assignee: Kabushiki Kaisha Toshiba, Minato-ku (JP)

(21) Appl. No.: 15/692,970

(22) Filed: Aug. 31, 2017

(30) Foreign Application Priority Data
Oct. 6, 2016 (JP) 2016-198407

(51) Int. Cl. G01K 11/32; G02B 6/122; G02B 6/125

(52) U.S. Cl. CPC G01K 11/32; G02B 2006/12109; G02B 6/125; G02B 6/1228

(57) ABSTRACT

A temperature measurement device includes a light source, a first optical waveguide disposed on a surface of a desired region of an object to be measured, a second optical waveguide connected to one side of the first optical waveguide, a third optical waveguide connected to the other side of the first optical waveguide and guiding the lights guided from the light source to the first optical waveguide, a first filter transmitting light in a first frequency band among the lights, a second filter transmitting light in a second frequency band among the lights, a detector circuit detecting each intensity of the lights in the first frequency band and the second frequency band, and a controller calculating a temperature of the desired region from the detected intensity of the each light in the first and second frequency bands.

### CROSS REFERENCE TO RELATED APPLICATION(S)

This application is based upon and claims the benefit of priority from the prior Japanese Patent Application No. 2016-198407, filed on Oct. 6, 2016, the entire contents of which are incorporated herein by reference.

### FIELD

Embodiment described herein generally relates to a temperature measurement device.

### BACKGROUND

Some temperature measurement devices which convert heat into an electric signal have been known, but as for such devices there is a problem that a temperature may not be measured accurately under an electromagnetic noise environment.

Further, when an electric material is used for the temperature measurement device, short-circuiting may possibly occur. Therefore, recently a temperature measurement device applying an optical waveguide such as an optical fiber, which uses light rather than the electric signal as a signal, has been developed.

An optical fiber thermometer, a fluorescent optical fiber thermometer, a temperature distribution measurement system using a Raman scattering, and the like have been devised as the temperature measurement device using the optical waveguide. They mainly use optical fibers for long distances to be used in large-scale infrastructure facilities such as power generation plants and plant facilities, and are suitable for measuring a temperature in a wide area.

Meanwhile, there is a demand for a temperature measurement device which is capable of measuring a temperature in a narrow region such as a surface of a semiconductor device, for example, 500 square micrometers or less.

### BRIEF DESCRIPTION OF DRAWINGS

FIG. 1 is an entire view of a temperature measurement device in a first embodiment.

FIG. 2A and FIG. 2B are enlarged views of an optical waveguide of the temperature measurement device in the first embodiment.

FIG. 3 is a perspective view of the optical waveguide of the temperature measurement device in the first embodiment.

FIG. 4 is a relationship between an intensity and a frequency of scattered light.

FIG. 5 is an entire view of a temperature measurement device in a second embodiment.

FIG. 6 is an entire view of a temperature measurement device in a third embodiment.

### DESCRIPTION OF EMBODIMENTS

According to one embodiment, a temperature measurement device that includes a light source, a first optical waveguide having one side and another side and disposed on a surface of a desired region of an object to be measured, a second optical waveguide connected to the one side of the first optical waveguide, the second optical guide guiding lights from the light source to the first optical waveguide, a third optical waveguide connected to the other side of the first optical waveguide, the third optical guide guiding the lights guided to the first optical waveguide, a first filter transmitting light in a first frequency band among the lights guided to the third optical waveguide, a second filter transmitting light in a second frequency band among the lights guided to the third optical waveguide, a detector circuit detecting an intensity of the light in the first frequency band and an intensity of the light in the second frequency band, and a controller calculating a temperature of the desired region of the measured object from the detected intensity of the light in the first frequency band and the detected intensity of the light in the second frequency band, is provided.

Embodiments of the present invention will be described below with reference to the drawings. Those with the same reference numerals indicate similar items. The drawings are schematic or conceptual, and a relationship between a thickness and a width of each part, a ratio coefficient of the size between the parts, and the like are not necessarily the same as the actual ones. Even when the same parts are represented, dimensions and ratio coefficients of the parts may be different from each other depending on the drawing.

### First Embodiment

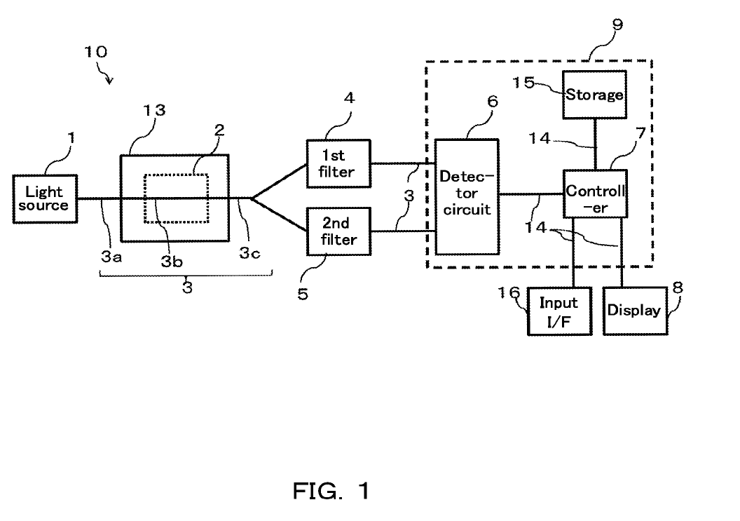

FIG. 1 illustrates an entire view of a temperature measurement device.

A temperature measurement device 10 includes a light source 1, optical waveguides 3, 3a, 3b and 3c, a first filter 4, a second filter 5, a display 8, a driving circuit 9, and an input interface 16.

A measured object of the temperature measurement device 10 is a desired region (a first region 2) on a surface of a semiconductor substrate 13. A measured object is not limited to a semiconductor substrate but may be any object. Since the temperature measurement device of the present embodiment can perform a measurement without being affected by electromagnetic wave noise, it may be suitably applied to an object having a member such as a metal which affects an electromagnetic wave, for example, a semiconductor device such as an electronic component, a semiconductor device, a semiconductor substrate, and the like. Further, it may be applied to a measurement for a high-voltage power device or a high-frequency device which emits particularly large electromagnetic wave noises.

In the present embodiment, a temperature of the first region 2 is measured by disposing the optical waveguide 3b in the first region 2 on the semiconductor substrate 13.

Herein, according to the embodiment, the first region on the semiconductor substrate 13 to be measured and optical waveguides 3a, 3b and 3C are provided on one semiconductor chip, for example. The light source 1 and the driving circuit 9, may be included in another semiconductor chip or configured in a different form of the semiconductor chip. The temperature measurement device 10 may also possibly be configured with one chip.

The light source 1 is, for example, a semiconductor laser light source. The light source 1 emits a coherent light having a wavelength of 1.5 μm, for example.

One side of the optical waveguide 3a is connected to the light source 1. The light source 1 and the optical waveguides 3a, 3b, 3c are connected in this order. The light emitted from the light source 1 is provided as an incident light to the optical waveguide 3a and scattered in the optical waveguide 3a, the optical waveguide 3b, and the optical waveguide 3c, and the scattered light is guided in this order.

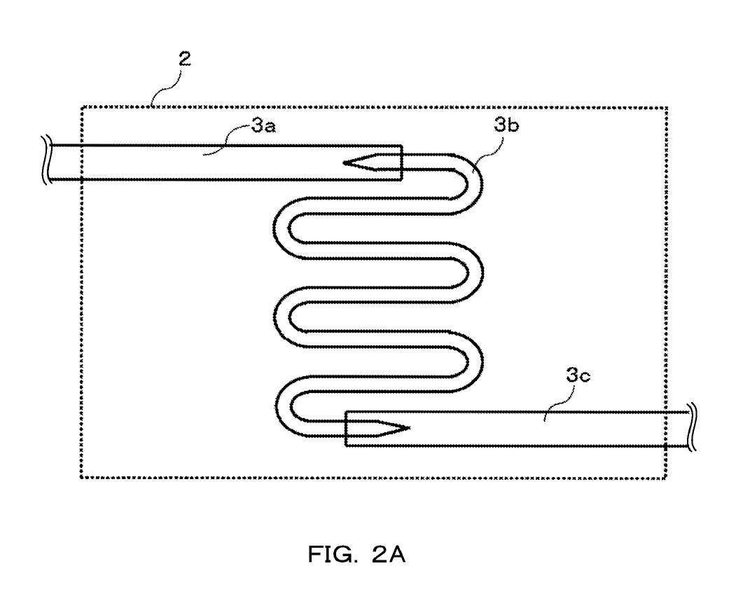

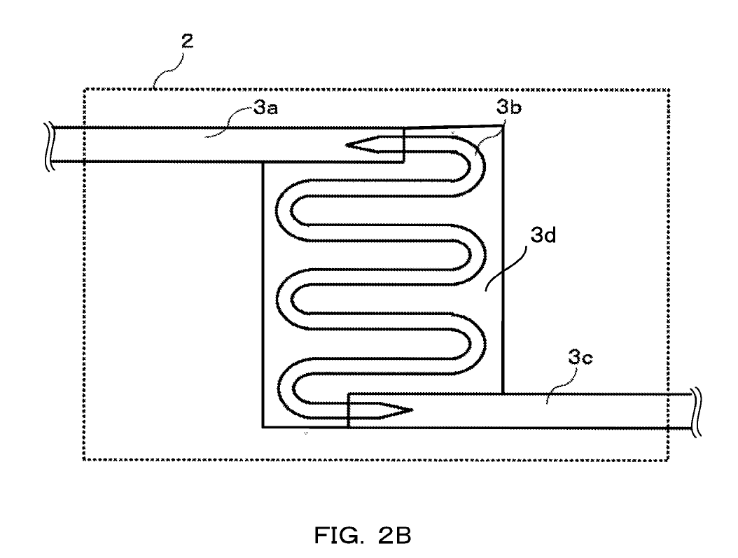

FIG. 2A illustrates an enlarged view of the optical waveguides 3a, 3b, and 3c arranged in the first region 2. As described above, the optical waveguides 3a, 3b, and 3c are connected in this order. That is, one end of the optical waveguide (a first optical waveguide) 3b is connected to the optical waveguide (a second optical waveguide) 3a. The other end of the optical waveguide 3b is connected to the optical waveguide (a third optical waveguide) 3c.

A refractive index of the material included in the optical waveguide 3b is larger than a refractive index of the material included in the optical waveguides 3a and 3c. As a result, a light guiding efficiency of incident light to the optical waveguide 3b is increased. The optical waveguide 3b is made of a material containing Si (silicon) such as, for example, a-Si, polysilicon, single crystal silicon or the like. Further, the optical waveguide 3b is made of a material containing, for example, any one of AlN, AlO, SiN, and GaN. In a case where the optical waveguide 3b is a material containing a-Si (amorphous silicon), the optical waveguides 3a and 3c are preferably made of a material containing SiON having a large refractive index difference. Further, in a case where the optical waveguide 3b is made of a material containing any one of AlN, AlO, SiN, and GaN, it is desirable that the optical waveguides 3a and 3c are made of a material containing SiO because a frequency of the scattered light in the optical waveguide 3b is different from a frequency of the scattered light in the optical waveguides 3a and 3c.

Line widths of the optical waveguides 3a and 3c are, for example, 2 μm. Thicknesses of the optical waveguides 3a and 3c are, for example, 1.2 μm.

The line width of the optical waveguide 3b is, for example, 400 nm. The thickness of the optical waveguide 3b is, for example, 220 nm.

In FIG. 2A, one side of the optical waveguides (the first optical waveguide) 3b is covered with the optical waveguide (the second optical waveguide) 3a. Another side of the optical waveguide 3b is covered with the optical waveguide (the third optical waveguide) 3c.

The optical waveguide 3b is disposed in the first region 2 on the semiconductor substrate 13 in order to measure a temperature of a region on the semiconductor substrate 13. In order to measure the temperature of the first region 2 more accurately, it is desirable that an area size of the optical waveguide 3b in contact with the first region 2 is increased. For example, as illustrated in FIG. 2A, the optical waveguide 3b, which is makes a long distance by having at least one meandering part, is arranged in the first region 2.

In order to guide light from the optical waveguide 3a to one side of the optical waveguide 3b, the one side of the optical waveguide 3b and the optical waveguide 3a are optically connected. The other side of the optical waveguide 3b and the optical waveguide 3c are also optically connected. In order to optically connect the one side of the optical waveguide 3b and the optical waveguide 3a, it is more desirable that the one side of the optical waveguide 3b is covered with the optical waveguide 3a. It may also be possible that the one side is in contact with or close to the optical waveguide 3a. Similarly, in order to optically connect the other side of the optical waveguide 3b and the optical waveguide 3c, it is more desirable that the other side of the optical waveguide 3b is covered with the optical waveguide 3c. It may also be possible that the other side is in contact with or close to the optical waveguide 3c.

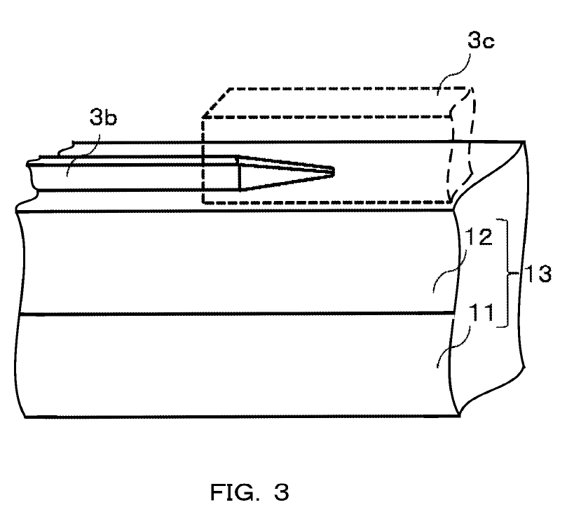

FIG. 3 is a perspective view of the optical waveguide 3b and the optical waveguide 3c on the semiconductor substrate 13 which is an object to be measured.

The semiconductor substrate 13 is composed of a substrate 11 and an insulating film 12, for example. The optical waveguide 3b and the optical waveguide 3c are located on the semiconductor substrate 13.

A shape of one end portion of the optical waveguide 3b the optical waveguide 3b which is covered with the optical waveguide 3c, is made narrow and tapered. Since the one end portion of the optical waveguide 3b is made narrow and tapered, the light is guided more easily in the optical waveguide 3b and the optical waveguide 3c. In addition, an optical coupling efficiency in the optical waveguide 3c of the optical waveguide 3b is improved.

Since a shape of another end portion of the optical waveguide 3b is also made narrow and tapered, an optical coupling efficiency between the one side of the optical waveguide 3b and the optical waveguide 3a is improved. That is, since the both end portions of the optical waveguide 3b are made narrow and tapered, the optical coupling efficiency in the optical waveguides 3a, 3b and 3c is improved.

Herein, as described, the one side of the optical waveguides 3b is covered with the optical waveguide 3a and the other side of the optical waveguides 3b is covered with the optical waveguide 3b. However, it may be possible that the entire optical waveguide 3b is covered with an optical waveguide (a fourth optical waveguide 3d) of the same manner as the optical waveguides 3a and 3c as shown in FIG. 2B.

In this case, the optical waveguide 3d is connected to the optical waveguides 3a and 3c. The optical waveguide 3d covers the optical waveguide 3b along a shape of the optical waveguide 3b. The optical waveguide 3d includes the same material as those of the optical waveguides 3a and 3c.

In consideration of improvement of the optical coupling efficiency, the end portions of the one side and the other side of the optical waveguide 3b may have other shapes rather than the tapered shape as illustrated.

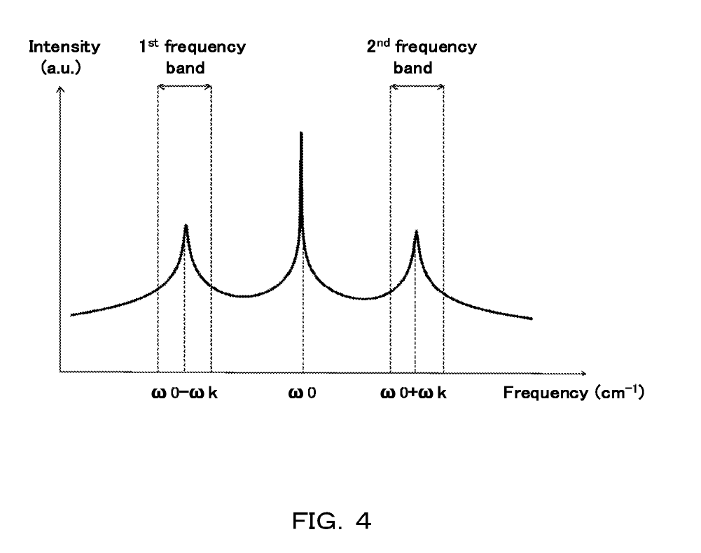

FIG. 4 illustrates a relationship between a frequency and an intensity of the scattered light guided through the optical waveguides 3a, 3b and 3c.

The horizontal axis shows the frequency (cm⁻¹) of the scattered light and the vertical axis shows the intensity (a.u.) of the scattered light. The intensity (a.u.) on the vertical axis is logarithmic.

ω₀ is a frequency of a scattered light having the same frequency as that of the light of the light source 1. Most of the scattered lights guided through the optical waveguides 3a, 3b and 3c have the same frequency ω₀ as that of the incident light from the light source 1. That is, the intensity of the scattered light having the frequency ω₀ is not almost deteriorated.

Among the scattered lights guided through the optical waveguides 3a, 3b and 3c, the light in a first frequency band lower than the frequency ω₀ is a Stokes light. A peak of the Stokes light appears at a position of a frequency ω₀−ωₖ in the first frequency band. Here, the frequency ωₖ is a frequency corresponding to a molecular vibration energy in a medium. That is, the value of the frequency ωₖ is determined based on the material included in the optical waveguide 3b. The peak intensity of the Stokes light at the position of the frequency ω₀−ωₖ in the first frequency band is used for analysis.

Among the scattered light guided through the optical waveguides 3a, 3b and 3c, the light in a second frequency band higher than the frequency ω₀ is an anti-Stokes light. A peak of the anti-Stokes light appears at a position of a frequency ω₀+ωₖ in the second frequency band. The peak intensity of the anti-Stokes light at the position of the frequency ω₀+ωₖ in the second frequency band is used for analysis. Returning to FIG. 1, the optical waveguide 3c branches off in two directions and is connected to each of the first filter 4 and the second filter 5.

Thus, the scattered light from the optical waveguide 3c is guided to each of the first filter 4 and the second filter 5.

Each of the first filter 4 and the second filter 5 is, for example, a bandpass filter. As the bandpass filter formed on the optical waveguide, a filter configured by modulating a period of a diffraction grating, a filter using an optical resonator or the like is used.

The first filter 4 transmits, for example, scattered light in the first frequency band among the scattered lights guided by the optical waveguide 3c. By changing a type of a band pass filter of the first filter 4, it is possible to change a frequency band of the scattered light passing through the first filter 4. As the first filter 4, for example, a band pass filter of a frequency band (1360 nm to 1420 nm) through which Stokes light is transmitted is used.

The second filter 5 transmits, for example, the scattered light in the second frequency band among the scattered lights guided by the optical waveguide 3c. By changing a type of a band pass filter of the second filter 5, a frequency band of the scattered light passing through the second filter 5 may be changed. For example, a band pass filter of a frequency band (1600 nm to 1660 nm) through which anti-Stokes light is transmitted is used as the second filter 5. In addition, for example, the first filter 4 may transmit anti-Stokes light and the second filter 5 may transmit Stokes light.

The driving circuit 9 includes a detector circuit 6, a controller 7, a storage 15, and a signal cable 14.

The detector circuit 6 is connected to each of the first filter 4 and the second filter 5 via the optical waveguide 3 therebetween. The detector circuit 6 detects the Stokes light which transmitted through the first filter 4. The detector circuit 6 detects the anti-Stokes light which was transmitted through the second filter 5.

The controller 7 is connected to the detector circuit 6 via the signal cable 14. The controller 7 controls the entire operation of the temperature measurement device 10.

Using an intensity I_{S} of the Stokes light of the frequency ω₀−ωₖ, an intensity I_{AS} of the anti-Stokes light of the frequency ω₀+ωₖ, the frequency ω₀−ωₖ of the Stokes light and the frequency ω₀+ωₖ of the anti-Stokes light, the controller 7 calculates a value of a temperature T(K) from the following equation,

$$\frac{{I}_{AS}}{{I}_{S}} = {( \frac{{ω}_{0} - {ω}_{k}}{{ω}_{0} + {ω}_{k}} )}^{4} exp ( - \frac{ℏ {ω}_{k}}{{k}_{B} T} ) \qquad [ Equation 1 ]$$

wherein k_{B} is Boltzmann constant, and [symbol] is Planck's constant. The Boltzmann constant (k_{B}) and Planck's constant ( [symbol] ) are known, and a peak intensity ratio I_{AS}/I_{S}, the frequency ω₀+ωₖ, and the frequency ω₀−ωₖ are measured values. Thus, by substituting these values into the equation, the temperature T(K) can be calculated.

For example, when Si is used for the optical waveguide 3b, the frequency ωₖ is about 520 cm⁻¹. Therefore, when the value of I_{AS}/I_{S} is 0.1, a temperature of the first region 2 on the semiconductor substrate 13 is calculated as 450 K. Here, the material included in the optical waveguide 3b are the same above, the temperature of the first region 2 on the semiconductor substrate 13 is determined by the value of I_{AS}/I_{S}. That is, the intensity I_{S} of the Stokes light and the intensity I_{AS} of the anti-Stokes light are variably detected, depending on the temperature of the first region 2.

The controller 7 controls to display the measured temperature on the display 8.

The storage 15 stores values of the frequency ωₖ that varies depending on the material of the optical waveguide 3b, the frequency ω₀ of the scattered light having the same frequency as that of the light of the light source 1, or the above equation.

The input interface 16 transfers information of various instructions and various settings inputted by an operator's operation of a mouse or a keyboard or the like to the controller 7. The input interface 16 receives settings of various values in the above equation, a measurement frequency and the like from the operator.

The display 8 is connected to the controller 7. The display 8 is a monitor device referred to by the operator. Under the control of the controller 7, the display 8 displays the temperature of the first region 2 on the semiconductor substrate 13 calculated by the controller 7. The display 8 displays various types of instructions from the operator via the input interface 16.

The detector circuit 6 and the controller 7 may be driven by one control circuit or may be separately driven.

According to the temperature measurement device 10 of the present embodiment, since the optical waveguide having a thin line (a line width is thin) is used for a sensing of the temperature of the measured object by it is possible to measure a temperature of a narrow region such as a surface of a semiconductor device. Further, since the temperature measurement device 10 of the present embodiment performs sensing of the temperature by using a change of optical signals obtained from the Stokes light and the anti-Stokes light, the temperature measurement device 10 is not affected by an electromagnetic wave noise even under an environment where the electromagnetic wave noise occurs, and is capable of measuring a temperature of a desired region accurately.

### Second Embodiment

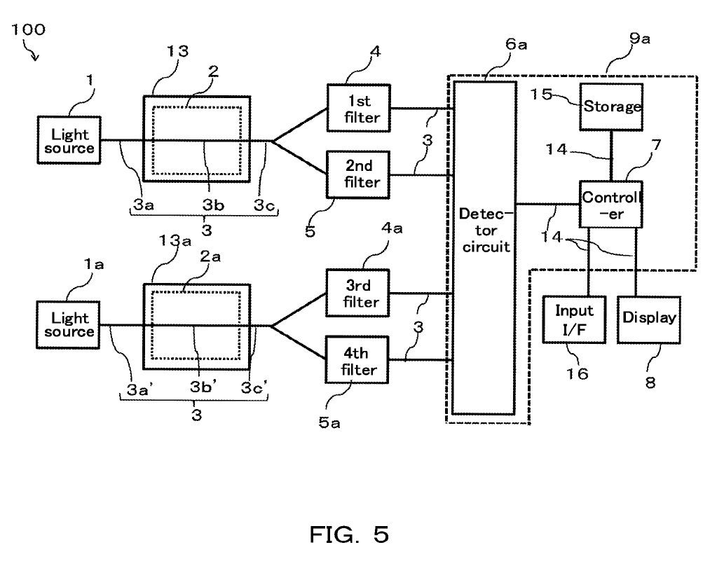

FIG. 5 illustrates a temperature measurement device 100 according to a second embodiment.

Parts similar to those of the first embodiment and FIGS. 1 to 3 are denoted by the same reference numerals, and descriptions thereof are omitted.

The temperature measurement device 100 includes light sources 1 and 1a, optical waveguides 3, 3a, 3a′, 3b, 3b′, 3c and 3c′, a first filter 4, a second filter 5, a third filter 4a, a fourth filter 5a, a display 8, a driving circuit 9a and an input interface 16.

Measured objects of the temperature measurement device 100 are a desired region (a first region 2) on a semiconductor element 13 and a desired region (a second region 2a), which is different from the first region 2, on a semiconductor element 13a. The temperature measurement device 100 is different from the temperature measurement device 10 of the first embodiment in that it can measure two regions respectively on the semiconductor elements 13 and 13a. Therefore, it is possible to grasp temperatures of a plurality of places in the measured object.

Herein, the measured objects may be regions 2, 2a provided on one semiconductor substrate or regions 2, 2a, each provided on two semiconductor substrates respectively. The measured objects may also be regions 2, 2a provided on one semiconductor device or regions, each provided on two semiconductor devices respectively. In the second embodiment, the regions 2, 2a are supposed to be provided on the same semiconductor substrate. The measured object is not limited to the semiconductor element, but may be any object. However, since the temperature measurement device of the present embodiment can perform a measurement without being affected by the electromagnetic wave noise, the device is appropriate for a measurement of a high-voltage power device or a high-frequency device, which emits a large electromagnetic noise.

By disposing the optical waveguide 3b in the first region 2 on the semiconductor substrate 13, it is possible to measure the temperature of the first region 2. Further, by disposing the optical waveguide 3b′ in the second region 2a on the semiconductor substrate 13a, the temperature of the second region 2a can be measured.

The light source 1a is similar to the light source 1, and is, for example, a semiconductor laser light source.

The optical waveguide 3a and the optical waveguide 3a′ have the same shape and contain the same material. The optical waveguide 3b and the optical waveguide 3b′ have the same shape and contain the same material. The optical waveguide 3c and the optical waveguide 3c′ have the same shape and contain the same material.

The optical waveguide 3a′ is connected to the light source 1a. The light emitted from the light source 1a provided as an incident light to the optical waveguides 3a′ and scattered in the optical waveguide 3a′, the optical waveguide 3b′ and the optical waveguide 3c′, and the scattered light is guided in this order.

The second region 2a is an arbitrary region on the semiconductor substrate 13a. The optical waveguide 3b′ is arranged in the second region 2a. By arranging the optical waveguide 3b′ in the second region 2a on the semiconductor substrate 13a, the temperature of the second region 2a can be measured.

The optical waveguide 3c′ branches off in two directions and is connected to each of the third filter 4a and the fourth filter 5a.

The scattered light of the optical waveguide 3c′ is guided to the third filter 4a and the fourth filter 5a, respectively.

Each of the third filter 4a and the fourth filter 5a is, for example, a band-pass filter. The third filter 4a transmits the anti-Stokes light, and the fourth filter 5a transmits the Stokes light.

In addition, for example, the third filter 4a may transmit Stokes light and the fourth filter 5a may transmit the anti-Stokes light.

The driving circuit 9a includes a detector circuit 6a, a controller 7, a storage 15, and a signal cable 14.

The detector circuit 6a is connected to the first filter 4, the second filter 5, the third filter 4a, and the fourth filter 5a, respectively, via the optical waveguide 3. The detector circuit 6a detects the Stokes light which was transmitted through each of the first filter 4 and the third filter 4a. The detector circuit 6a also detects the anti-Stokes light which was transmitted through the second filter 5 and the fourth filter 5a.

The controller 7 calculates the temperatures of each of the first region 2 and the second region 2a.

The storage 15 also stores a value of a frequency ωₖ or the above equation, which differ depending on the materials of the optical waveguides 3a, 3a′, 3b, 3b′, 3c and 3c′.

The input interface 16 transfers information of various instructions and various settings inputted by an operator's operation of a mouse or a keyboard or the like to the controller 7. The input interface 16 receives settings of various values in the above equation, a measurement frequency and the like from the operator.

The display 8 is connected to the controller 7. The display 8 is a monitor device referred to by an operator. Under the control of the controller 7, the display 8 displays the temperature of the first region 2 and the second region 2a calculated by the controller 7. The display 8 displays various instructions from the operator via the input interface 16.

It is possible to simultaneously measure the temperatures of the first region 2 and the second region 2a by the temperature measurement device 100. Therefore, it is possible to grasp a temperature distribution of a measured object. In the embodiment, the example of measuring the temperatures at two places is described, but it is possible to measure the temperatures at more than two places by increasing the numbers of the light source, the optical waveguides and the filters.

Thus, according to the second embodiment, as at least two regions of the temperature can be measured, so more accurate measurement on around the regions of the measured object is possible if the regions are very close with each other. Moreover, observing a temperature distribution on the measured objects is possible if some of the regions are selected with discrete positions. Accordingly, such various observation of the temperature can be realized.

Although the example in which the light sources 1 and 1a are respectively provided is shown, it is also possible to divide an output of a single light source so that a light from the light source is shared and input to each of the optical waveguides 3a and 3a′.

Accordingly, the measurement device makes more simple with low consumption of energy and low cost.

### Third Embodiment

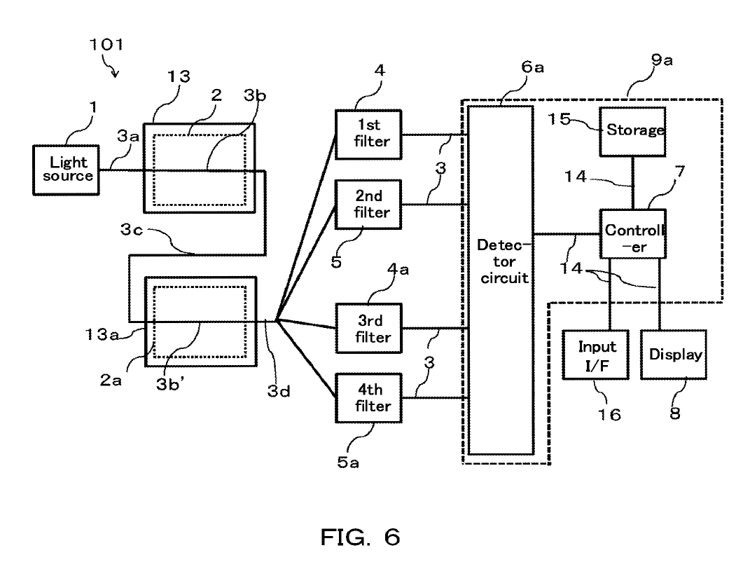

FIG. 6 illustrates a temperature measurement device 101 according to a third embodiment.

The parts similar to those in FIG. 5 are denoted by the same reference numerals, and descriptions thereof are omitted.

The temperature measurement device 101 includes a light source 1, optical waveguides 3a, 3b, 3b′, 3c and 3d, a first filter 4, a second filter 5, a third filter 4a, a fourth filter 5a, a display 8, a driving circuit 9a, and an input interface 16.

As in the temperature measurement device 101, it is possible to measure the temperature of each of the first region 2 and the second region 2a, using optical waveguides 3a, 3b, 3b′, 3c and 3d connected as a single optical waveguide. In this case, the optical waveguide 3b is disposed in the first region 2 and the optical waveguide 3b′ is disposed in the second region 2a.

By changing a material of the optical waveguide 3b disposed in the first region 2 and a material of the optical waveguide 3b′ disposed in the second region 2a, a frequency ωₖ, may be obtained which differs depending on a measurement part. For example, a case is considered where Si is used for the material of the optical waveguide 3b of the first region 2 and AlO is used for the material of the optical waveguide 3b′ of the second region 2a. At this time, a frequency ωₖ₁ of the scattered light guided through the optical waveguide 3b of the first region 2 is about 520 cm⁻¹, a frequency ωₖ₂ of the scattered light guided through the optical waveguide 3b′ of the second region 2a is 395 cm⁻¹. Therefore, the optical waveguide 3d branches off into four parts. A first filter 4 that transmits a Stokes light of a frequency ωₖ₁, a second filter 5 that transmits an anti-Stokes light of the frequency ωₖ₁, a third filter 4a that transmits a Stokes light of a frequency ωₖ₂, and a fourth filter 5a that transmits an anti-Stokes light of the frequency ωₖ₂ are disposed in the optical waveguides 3d, which branches off into four parts, respectively. It is possible to measure a temperature of the first region 2 from the scattered light transmitted through the first filter 4 and the second filter 5. It is possible to measure a temperature of the second region 2a from the scattered light transmitted through the third filter 4a and the fourth filter 5a.

According to the third embodiment, as two different frequencies of lights are available, two desired ranges of temperature can be measured by selecting desired materials of optical waveguides 3b and 3b′. Adding above, making the measurement device more simple with low consumption of energy and low cost can be realized as described in the second embodiment.

While several embodiments of the present invention have been described, these embodiments are presented by way of example and are not intended to limit the scope of the invention. The embodiments can be implemented in various other forms, and various omissions, substitutions, and changes can be made without departing from the gist of the invention. The embodiments and their modifications are included in the scope and gist of the description as well as the invention described in the claims and the equivalent scope thereof.

What is claimed is:

1. A temperature measurement device comprising:
a light source;
a first optical waveguide having one side and another side, and disposed on a surface of a desired region of an object to be measured;
a second optical waveguide connected to the one side of the first optical waveguide, the second optical waveguide guiding lights from the light source to the first optical waveguide;
a third optical waveguide connected to the other side of the first optical waveguide, the third optical waveguide guiding the lights guided to the first optical waveguide;
a first filter transmitting light in a first frequency band among the lights guided to the third optical waveguide;
a second filter transmitting light in a second frequency band among the lights guided to the third optical waveguide;
a detector circuit detecting an intensity of the light in the first frequency band and an intensity of the light in the second frequency band; and
a controller calculating a temperature of the desired region of the object from the detected intensity of the light in the first frequency band and the detected intensity of the light in the second frequency band.

2. The temperature measurement device according to claim 1, wherein the second optical waveguide covers the one side of the first optical waveguide, and the third optical waveguide covers the other side of the first optical waveguide.

3. The temperature measurement device according to claim 1, wherein a refractive index of the first optical waveguide is different from a refractive index of the second optical waveguide or a refractive index of the third optical waveguide.

4. The temperature measurement device according to claim 1, wherein the one side and the other side of the first optical waveguide are tapered respectively.

5. The temperature measurement device according to claim 1, wherein the first optical waveguide includes Si.

6. The temperature measurement device according to claim 1, wherein the second optical waveguide and the third optical waveguide include SiON respectively.

7. The temperature measurement device according to claim 1, wherein, when the second optical waveguide and the third optical waveguide include SiO, the first optical waveguide includes any one of AlN, AlO, SiN, and GaN.

8. The temperature measurement device according to claim 1, further comprising:
a fourth optical waveguide connected to the second optical waveguide and the third optical waveguide, the fourth optical waveguide covering the first optical waveguide.

9. A temperature measurement device comprising:
a light source to emit light;
a first optical waveguide having one side and the other side, the first optical waveguide arranged on a surface region of a semiconductor substrate;
a second optical waveguide connected to the one side of the first optical waveguide, the second optical waveguide guiding the light emitted from the light source to the first optical waveguide;
a first filter transmitting light in a first frequency band among the light guided from the other side of the first optical waveguide;
a second filter transmitting light in a second frequency band among the light guided from the other side of the first optical waveguide;
a detector circuit detecting a first intensity of the transmitted light in the first frequency band and a second intensity of the transmitted light in the second frequency band;
a controller calculating a temperature of the surface region of the semiconductor substrate from the detected first intensity and second intensity.

10. The temperature measurement device according to claim 9, further comprising:
a third optical waveguide connected to the other side of the first optical waveguide and guiding the lights guided to the first optical waveguide, and wherein
the second optical waveguide covers the one side of the first optical waveguide and the third optical waveguide covers the other side of the first optical waveguide.

11. The temperature measurement device according to claim 10, wherein a refractive index of the first optical waveguide is different from a refractive index of the second optical waveguide or a refractive index of the third optical waveguide.

12. The temperature measurement device according to claim 9, wherein the one side and the other side of the first optical waveguide are tapered respectively.

13. The temperature measurement device according to claim 9, wherein the first optical waveguide includes Si.

14. The temperature measurement device according to claim 10, wherein the second optical waveguide and the third optical waveguide include SiON respectively.

15. The temperature measurement device according to claim 10, wherein, when the second optical waveguide and the third optical waveguide include SiO, the first optical waveguide includes any one of AlN, AlO, SiN, and GaN.

16. The temperature measurement device according to claim 10, further comprising:
a fourth optical waveguide connected to the second optical waveguide and the third optical waveguide, and covering the first optical waveguide.

17. A temperature measurement device comprising:
a light source to emit light;
a first optical waveguide having one side and the other side, arranged on a surface region of a semiconductor substrate and having a first refractive index;
a second optical waveguide connected to the one side of the first optical waveguide, guiding the light emitted from the light source to the first optical waveguide and having a second refractive index different from the first refractive index of the first optical waveguide;
a first filter configured to transmit light in a first frequency band among the light guided from the other side of the first optical waveguide;
a second filter configured to transmit light in a second frequency band among the light guided from the other side of the first optical waveguide;
a detector circuit configured to detect a first intensity of the transmitted light of the first frequency band and a second intensity of the transmitted light of the second frequency band;
a controller configured to calculate a temperature of the surface region of the semiconductor substrate from the detected first intensity and second intensity.
